(19) United States
(12) Patent Application Publication
(10) Pub. No.: US 2022/0242686 A1
(43) Pub. Date: Aug. 4, 2022

(54) DRIVING CONTROL OF PRINT MEDIUM FEEDING DEVICE

(71) Applicant: Hewlett-Packard Development Company, L.P., Spring, TX (US)

(72) Inventors: Ji-Hoon WOO, Seongnam-si (KR); Sanghyun SEO, Seongnam-si (KR)

(21) Appl. No.: 17/612,675

(22) PCT Filed: Apr. 24, 2020
(86) PCT No.: PCT/US2020/029740

§ 371 Date: Nov. 19, 2021

(30) Foreign Application Priority Data
Nov. 28, 2019 (KR) 10-2019-0155769

(51) Int. Cl. B65H 9/00; B65H 7/08

(52) U.S. Cl. CPC B65H 9/006; B65H 7/08; B65H 2511/242; B65H 2801/06; B65H 2513/53; B65H 2553/612; B65H 2513/514

(57) ABSTRACT

A print medium feeding device comprises a pickup roller, a forward roller, a registration roller, a sensing unit, and a processor. The processor adjusts a first driving signal and a second driving signal based on a difference between a first time and a second time and controls driving of the registration roller using adjusted signals, the first driving signal adjusting a waiting position of the print medium in the registration roller, the second driving signal feeding the print medium waiting at the adjusted waiting position to the image forming unit, the first time associated with transport of the print medium from the pickup roller to the sensing unit, and the second time being measured by sensing the print medium transported from the pickup roller to the sensing unit.

### BACKGROUND

An image forming apparatus such as a printer, a copy machine, or a multi-function printer feeds each of print media stacked on a loading tray to an image forming unit therein and forms an image on a print medium. For feeding of a print medium from a loading tray to an image forming unit, a print medium may be fed according to the kind or model of image forming apparatus.

### BRIEF DESCRIPTION OF DRAWINGS

FIG. 1 is a diagram for describing an example schematic structure and operations of an image forming apparatus.

FIGS. 2A and 2B are diagrams for describing an example operation of a print medium feeding device feeding each of print media stacked on a loading tray,

FIG. 3 is a diagram for describing an example driving of a pickup roller, sensing of a print medium by a registration sensor, driving of a registration roller, and synchronization with an image forming process during feeding of the print medium by a print medium feeding device.

FIGS. 4A through 4C are diagrams for describing example events occurring in a print medium when a print medium feeding device feeds the print medium having the front-end protruding from a certain pickup position,

FIG. 5 is a diagram for describing an example driving of a pickup roller, sensing of a print medium by a registration sensor, driving of a registration roller, and synchronization with an image forming process while a print medium feeding device is feeding the print medium having the front-end protruding from a certain pickup position.

FIGS. 6A and 6B are diagrams for describing an example operation of controlling the driving of a registration roller based on the degree of protrusion of the front end of a print medium from a certain pickup position when a print medium feeding device feeds the print medium having the front end protruded.

FIG. 7 is a diagram for describing an example adjustment of signals for controlling the driving of a registration roller while a print medium feeding device is feeding a print medium having the front-end protruding from a certain pickup position.

FIG. 8 is a flowchart of an example method of controlling a print medium feeding device.

### DETAILED DESCRIPTION OF EXAMPLES

Hereinafter, various examples are described in detail with reference to the drawings. In the specification and drawings, like elements having substantially the same functional configurations are denoted by like reference numerals, and thus their description is omitted.

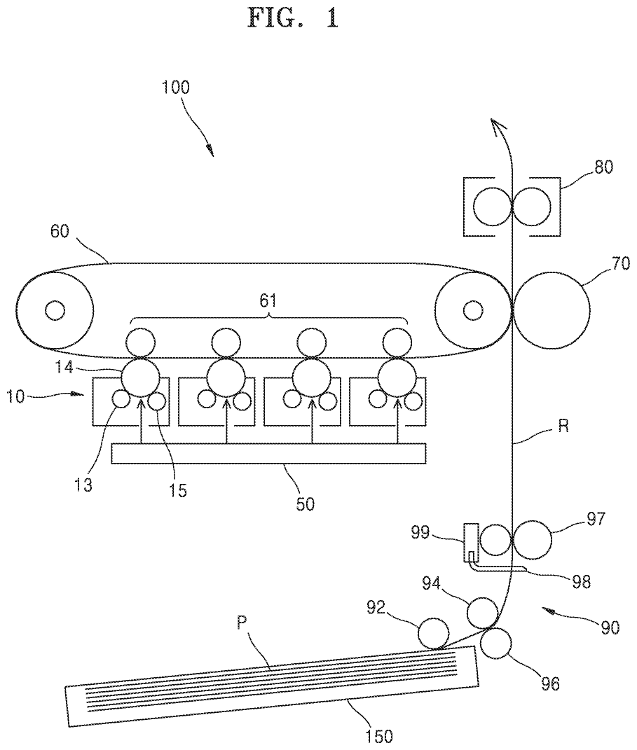

FIG. 1 is a diagram for describing an example schematic structure and operations of an image forming apparatus 100. The image forming apparatus 100 may print a color image using electrophotographic development.

The image forming apparatus 100 includes devices, such as printers, copy machines, multi-function printers, and fax machines, which perform an image forming job. The image forming job may refer to a job involving an image, e.g., printing, copying, scanning, or faxing, and may include a series of processes necessary for the execution of the image forming job.

A developing device 10 may include a photoconductor 14, on the surface of which an electrostatic latent image is formed, and a developing roller 13, which provides a developer to the electrostatic latent image to develop the electrostatic latent image into a visible toner image. A photosensitive drum is an example of the photoconductor 14 and may include an organic photo conductor (OPC). A charging roller 15 is an example of a charger that charges a surface of the photoconductor 14 to a substantially uniform potential. A developer accommodated in a developer cartridge (not shown) may be provided to the developing device 10. The developer accommodated in the developer cartridge may be a toner.

An exposure device 50 forms an electrostatic latent image on the photoconductor 14 by radiating light, which can be modulated according to image information, to the photoconductor 14. A laser scanning unit (LSU) is an example of the exposure device 50.

In some examples, a transfer unit transfers a toner image on the photoconductor 14 to a print medium P and may include an intermediate transfer unit. For example, the transfer unit may include an intermediate transfer member 60, an intermediate transfer roller 61, and a transfer roller 70, as shown in FIG. 1. An intermediate transfer belt is an example of the intermediate transfer member 60, to which a toner image developed on the photoconductor 14 of the developing device 10 is transferred and may temporarily hold the toner image. An intermediate transfer bias may be applied to the intermediate transfer roller 61 to intermediately transfer the toner image on the photoconductor 14 to the intermediate transfer member 60. The transfer roller 70 may be located to face the intermediate transfer member 60. A transfer bias may be applied to the transfer roller 70 to transfer the toner image on the intermediate transfer member 60 to the print medium P.

A fusing unit 80 may fuse a toner image to the print medium P by applying heat and/or pressure to the toner image on the print medium P.

In some examples, due to the configuration described above, the exposure device 50 may form an electrostatic latent image on the photoconductor 14 by scanning light modulated according to image information of a different color. Respective electrostatic latent images on photoconductors 14 respectively included in a plurality of developing devices 10 may be developed into visible toner images by cyan (C), magenta (M), yellow (Y), and black (K) developers provided from a plurality of developer cartridges (not shown) to the developing devices 10. The toner images may be sequentially and intermediately transferred to the intermediate transfer member 60.

In some examples, the print medium P in a loading tray 150 may be fed between the transfer roller 70 and the intermediate transfer member 60 along a feeding route R by a print medium feeding device 90. A toner image, which has been intermediately transferred to the intermediate transfer member 60, may be transferred to the print medium P, which is fed between the transfer roller 70 and the intermediate transfer member 60, by a transfer bias voltage applied to the transfer roller 70. In some examples, when the print medium P passes through the fusing unit 80, the toner image is fixed to the print medium P by heat and pressure. The print medium P having undergone fusing may be discharged by a discharge roller (not shown) in some instances.

The print medium feeding device 90 may include a plurality of rollers, e.g., a pickup roller 92, a forward roller 94, a retard roller 96, and a registration roller (hereinafter, referred to as a regi roller) 97, to feed the print medium P and a driving unit (not shown) that drives the rollers. The pickup roller 92 may pick up each print medium P stacked on the loading tray 150, and the forward roller 94 may transport the print medium P that has been picked up. In some examples, the retard roller 96 is located to engage with the forward roller 94 such that, when two print media P are inserted together between the forward roller 94 and the retard roller 96, a print medium P contacting the retard roller 96 is not transported and the two-print media P are separated from each other. The print medium feeding device 90 may further include a feed roller (not shown) according to the model of the image forming apparatus 100. The print medium P that is transported may be fed to the regi roller 97 along the feeding route R. The driving unit may drive a roller directly or via a power transmitter, such as a connecting gear or a clutch, connected to the roller.

A sensing unit (e.g., comprising an actuator 98 and a registration sensor 99, hereinafter, 98 and 99) may sense the front end of the print medium P fed to the regi roller 97 and can include an actuator 98 and a registration sensor (hereinafter, referred to as a regi sensor) 99. When the print medium P fed along the feeding route R meets the actuator 98, the actuator 98 may be rotated around a rotation axis by the print medium P, Based on a change involved in the rotation of the actuator 98, the regi sensor 99 may sense the front end of the print medium P and generate a signal indicating that the print medium P is fed to the regi roller 97.

In some examples, the regi roller 97 may align the front end of the print medium P and feed the print medium P to an image forming unit. The regi roller 97 may adjust a waiting position of the print medium P after the print medium P arrives at the regi roller 97 and may feed the print medium P, which is waiting at the adjusted position, to the image forming unit. In some examples, the regi roller 97 may correct front-end skew of the print medium P so that the front end of an image of an image forming job is aligned with the front end of the print medium P afterward. In some examples, when the front end of the print medium P is aligned with the front end of an image of an image forming job, an image formed on the intermediate transfer member 60 can be transferred to the print medium P and fused by the fusing unit 80.

In some examples, when the image forming apparatus 100 does not include a power regulator, such as a clutch, for the pickup roller 92 of the print medium feeding device 90, the print medium feeding device 90 can be designed based on the assumption that the print medium P is located in a certain pickup position such that the print medium P can be transported by a distance from the pickup roller 92 to the regi roller 97. In some example operations of the image forming apparatus 100, the print medium P may protrude from the certain pickup position predefined during the design. Examples described below include control of the print medium feeding device 90 according to a pickup position of the print medium P in the image forming apparatus 100 that does not include a power regulator, such as a clutch, for the pickup roller 92 of the print medium feeding device 90 in the case where the print medium P is picked up at a certain pickup position and in the case where the print medium P is picked up at a position protruding from the certain pickup position.

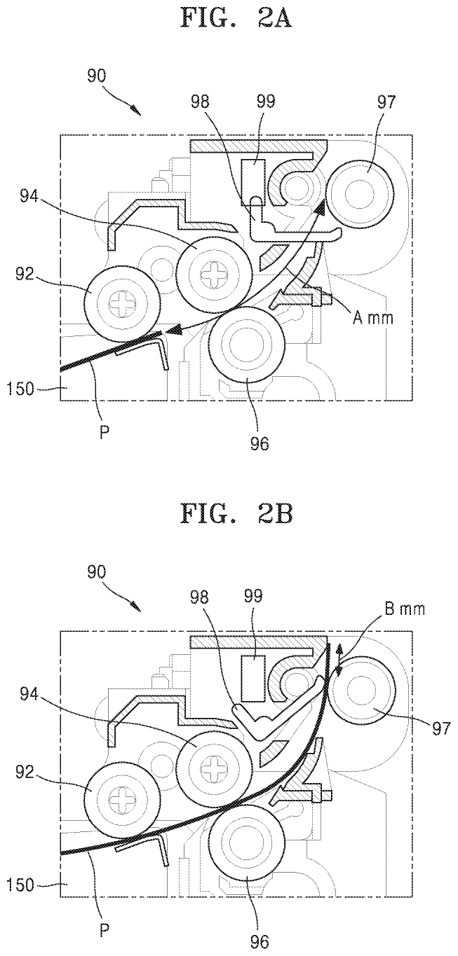

FIGS. 2A and 2B are diagrams for describing an example operation of the print medium feeding device 90 feeding each of the print media P stacked on the loading tray 150.

Referring to FIGS. 2A and 2B, the print medium feeding device 90 may include the pickup roller 92 picking up the print medium P from the loading tray 150, the forward roller 94 transporting the print medium P that has been picked up, the retard roller 96 operating in engagement with the forward roller 94, and the regi roller 97 aligning the front end of the print medium P and feeding the print medium P to an image forming unit. The print medium feeding device 90 may include the sensing unit 98 and 99 to sense the front end of the print medium P transported to the regi roller 97 in some examples. The sensing unit 98 and 99 can includes the actuator 98, which is rotated around a rotation axis and pushed by the front end of the print medium P, and the regi sensor 99, which can sense the front end of the print medium P based on a change involved in the rotation of the actuator 98.

The print medium feeding device 90 may feed the print medium P stacked on the loading tray 150 to the image forming unit using the pickup roller 92, the forward roller 94, and the regi roller 97. In some examples, for this operation, the print medium feeding device 90 may control the pickup roller 92, the forward roller 94, and the regi roller 97 based on a distance that the print medium P travels along a feeding route.

In some examples, the print medium feeding device 90 may preset the number of rotations of the pickup roller 92, which can pick up and transport the print medium P, such that the print medium P is transported a distance from the pickup roller 92 to the retard roller 96. For example, as shown in FIG. 2A, when the distance from the pickup roller 92 to the regi roller 97 is A millimeter(s) (mm) and the circumference of the pickup roller 92 is A/3 mm, the number of rotations of the pickup roller 92 may be 3.

In some examples, when the pickup roller 92 rotates as many times as the preset number, the print medium P can arrive at the regi roller 97 and front-end skew of the print medium P may be corrected. During this operation, the front end of the print medium P transported to the regi roller 97 can rotate and push the actuator 98, which is on the feeding route, around the rotation axis before arriving at the nip of the regi roller 97, and accordingly, the regi sensor 99 may sense the front end of the print medium P based on a change involved in the rotation of the actuator 98. As shown in FIG. 2B, responsive to correcting the front-end skew of the print medium P, the regi roller 97 may move a position of the print medium P, which can wait in the regi roller 97, by a distance of B mm. The print medium P waiting at the position after being further transported by B mm may be fed to the image forming unit by the retard roller 96, considering synchronization with an image forming process in some examples.

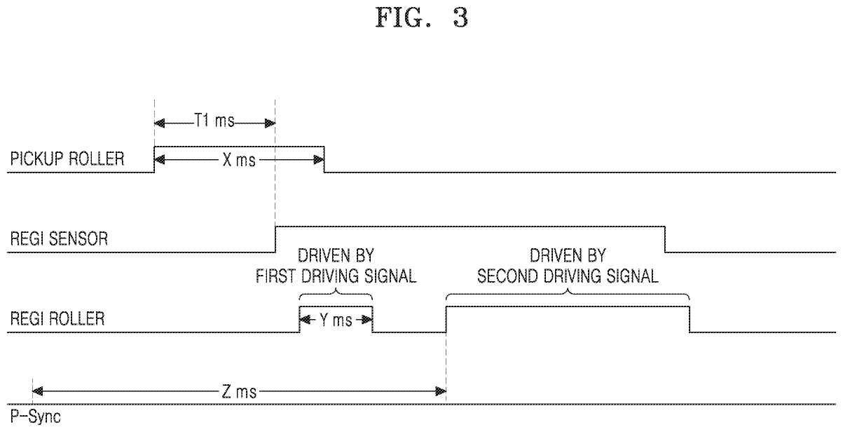

FIG. 3 is a diagram for describing an example driving of the pickup roller 92, sensing of the print medium P by the sensing unit 98 and 99, driving of the regi roller 97, and synchronization with an image forming process during the feeding of the print medium P by the print medium feeding device 90.

In some examples, when the print medium P is picked up at a certain pickup position, the print medium feeding device 90 may be controlled according to a time table shown in FIG. 3.

Referring to FIG. 3, X millisecond(s) (ms) is the time taken for the print medium P stacked on the loading tray 150 to be picked up by the pickup roller 92 at a certain pickup position and to be transported to the regi roller 97. For example, X ms may be a time taken for the print medium P to be transported the distance of A mm from the pickup roller 92 to the regi roller 97, as shown in FIG. 2A. T1 ms can be the time measured starting from when the print medium P is picked up by the pickup roller 92 at the certain pickup position to when the front end of the print medium P is sensed by the sensing unit 98 and 99. Y ms can be the time taken during which a waiting position of the print medium P having arrived at the regi roller 97 is adjusted by B mm, as shown in FIG. 2B, by controlling the driving of the regi roller 97 using a first driving signal. For synchronization with an image forming process, Z ms can be the time from a start point P-Sync of the image forming process to a point when the driving of the regi roller 97 is started by a second driving signal for transporting the print medium P to an image forming unit.

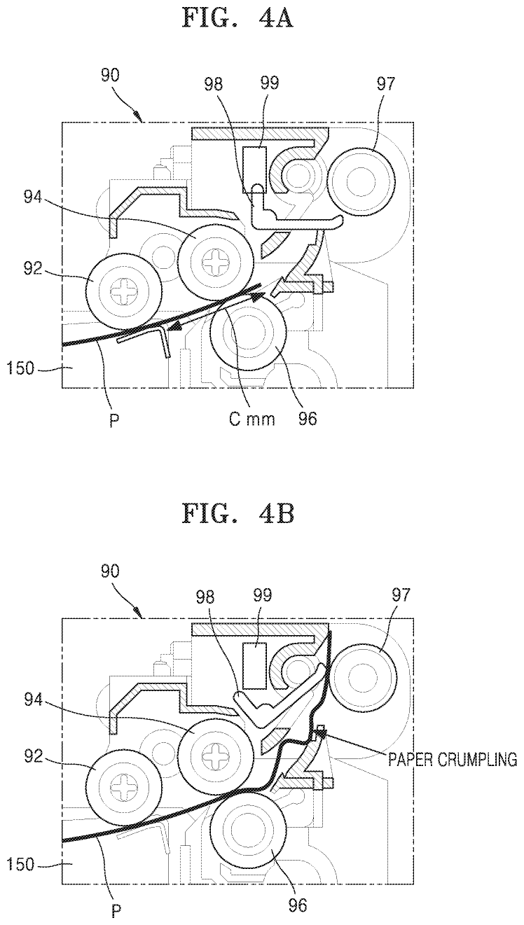

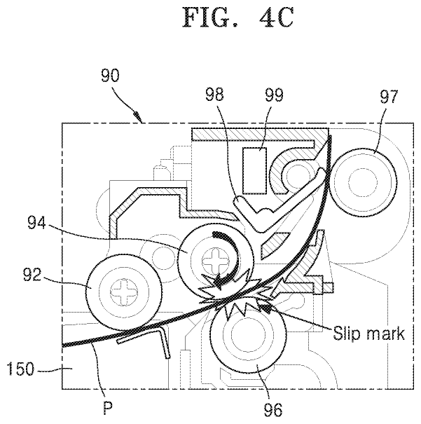

FIGS. 4A through 4C are diagrams for describing example events occurring in the print medium P when the print medium feeding device 90 feeds the print medium P having the front-end protruding from a certain pickup position.

FIG. 4A shows an example where the print medium P is picked up at a position protruding C mm from the certain pickup position shown in FIG. 2A. In such an example, the distance that the print medium P is transported decreases by C mm, by which the front end of the print medium P protrudes from the certain pickup position, from A mm in FIG. 2A (e.g., the distance between the pickup roller 92 and the regi roller 97). As a result, the front end of the print medium P transported to the regi roller 97 is sensed by the sensing unit 98 and 99 and arrives at the regi roller 97 earlier than expected. In some examples, because the image forming apparatus 100 does not include a power regulator, such as a clutch, for the pickup roller 92 of the print medium feeding device 90, the print medium feeding device 90 can continuously drive the pickup roller 92 even though the front end of the print medium P, which is transported toward the regi roller 97 since driving of the pickup roller 92, is sensed earlier and arrives at the regi roller 97 earlier. As a result, in some instances, because there is no space for further transport of the print medium P, the print medium P may be crumpled, as shown in FIG. 4B, or may have a slip mark, as shown in FIG. 4C.

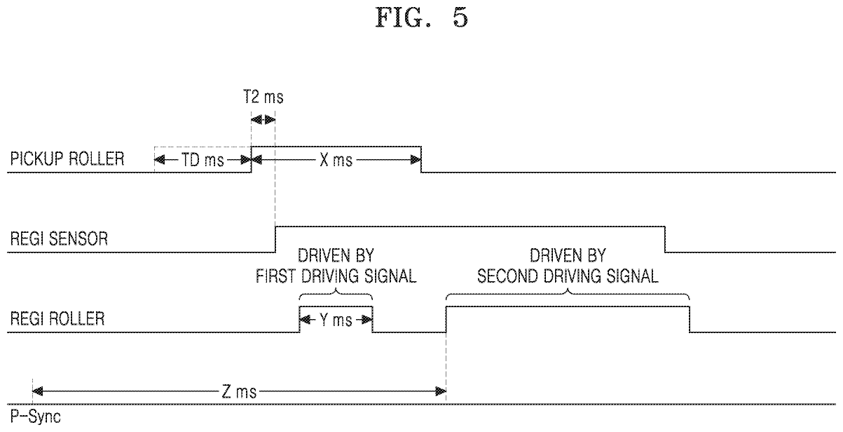

FIG. 5 is a diagram for describing an example driving of the pickup roller 92, sensing of the print medium P by the sensing unit 98 and 99, driving of the regi roller 97, and synchronization with an image forming process while the print medium feeding device 90 is feeding the print medium P having the front-end protruding from a certain pickup position.

In some examples, when the print medium P is picked up at a position protruding from the certain pickup position, the print medium feeding device 90 may be controlled according to a time table shown in FIG. 5.

Referring to FIG. 5, since the print medium feeding device 90 is designed based on the assumption that the print medium P is located in the certain pickup position such that the print medium P is transported by a distance from the pickup roller 92 to the regi roller 97, the pickup roller 92 can be driven for X ms, regardless of whether the front end of the print medium P protrudes or not.

In some instances, when the print medium P stacked on the loading tray 150 is picked up with the front end thereof protruded and is transported by the pickup roller 92 for X ms, the print medium P arrives at the regi roller 97 although, in some examples, the print medium P travels a distance that is less than the distance of A mm between the pickup roller 92 and the regi roller 97 by the degree of protrusion of the front end of the print medium P.

T2 ms can be the time measured by sensing the print medium P transported from the pickup roller 92 to the sensing unit 98 and 99. For instance, T2 ms can be the time measured from when the print medium P is picked up by the pickup roller 92 with the front end protruded to when the front end of the print medium P is sensed by the regi sensor 99, In some examples, because the distance that the print medium P is transported until the print medium P is sensed by the regi sensor 99 decreases due to the protrusion of the front end of the print medium P, the front end of the print medium P may be sensed in T2 ms that is shorter than T1 ms described with reference to FIG. 3.

TD ms can be the difference between the first time T1 set for (e.g., associated with) the transport of the print medium P from the pickup roller 92 to the sensing unit 98 and 99 and the second time T2 measured by sensing the print medium P transported from the pickup roller 92 to the sensing unit 98 and 99. For example, TD ms may be the difference between T1 ms that is the time premeasured starting from when the print medium P is picked up by the pickup roller 92 at the certain pickup position to when the front end of the print medium P is sensed by the sensing unit 98 and 99 and T2 ms that is the time measured from when the print medium P is picked up by the pickup roller 92 with the front end protruded to when the front end of the print medium P is sensed by the sensing unit 98 and 99. TD ms may be an indicator that indicates the degree of protrusion of the front end of the print medium P, in some examples.

TD=T1−T2 Equation 1:

With respect to Equation 1, T1 ms can be a predetermined value, and a value of TD ms can increase as a value of T2 ms decreases according to the degree of the protrusion of the front end of the print medium P. In other words, the more the front end of the print medium P protrudes, the greater the value of TD ms. This means that the time during which the print medium P is transported until the front end of the print medium P is sensed by the sensing unit 98 and 99 can be reduced by the degree of the protrusion of the front end of the print medium P.

As shown in FIG. 5, in some examples even after the print medium feeding device 90 adjusts a waiting position of the print medium P, which has arrived at the regi roller 97, by the distance of B mm by controlling the driving of the regi roller 97 using the first driving signal, the print medium feeding device 90 can continuously drive the pickup roller 92 until X ms elapses. As a result, because there is no space for further transport of the print medium P by the pickup roller 92, the print medium P may be crumpled or may have a slip mark.

Accordingly, for the image forming apparatus 100 that does not include a power regulator, such as a clutch, for the pickup roller 92 of the print medium feeding device 90, a process of feeding the print medium P can be based on the assumption that the print medium P is picked up at a certain pickup position. Therefore, when the print medium P is picked up at a position protruding from the certain pickup position, driving control of the print medium feeding device 90 can be used to prevent the print medium P from being crumpled or having a slip mark in some examples.

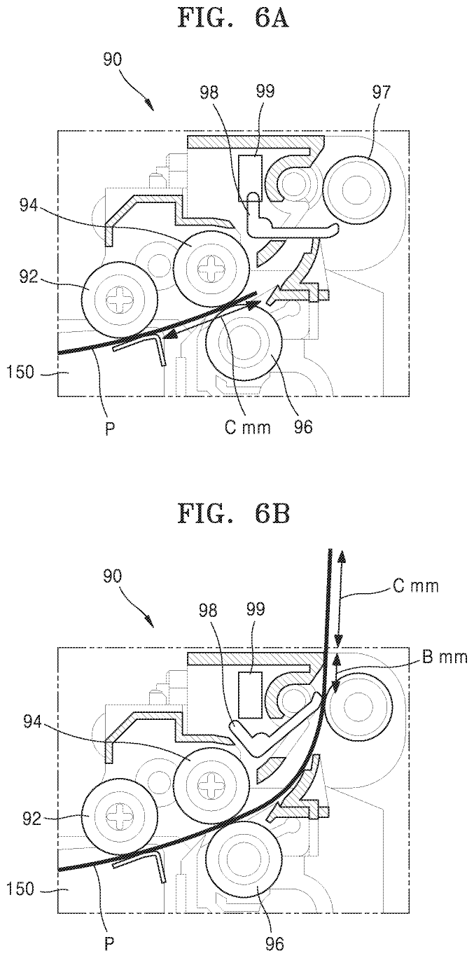

FIGS. 6A and 6B are diagrams for describing an example operation of controlling the driving of the regi roller 97 based on the degree of protrusion of the front end of the print medium P from a certain pickup position when the print medium feeding device 90 feeds the print medium P having the front end protruded.

FIG. 6A shows an example where the print medium P is picked up at a position protruding C mm from the certain pickup position shown in FIG. 2A. In such an example, the distance that the print medium P is transported decreases by C mm, by which the front end of the print medium P protrudes from the certain pickup position, from A mm in FIG. 2A that is the distance between the pickup roller 92 and the regi roller 97. As a result, there may not be space corresponding to C mm for the print medium P that is transported. Consequently, a portion of the print medium P corresponding to C mm may be crumpled or may have a slip mark. In some examples, to adjust the position of the print medium P, which has arrived at the regi roller 97, by C mm by which the front end of the print medium P protrudes, as shown in FIG. 6B, the driving of the regi roller 97 may be controlled as described below.

The sensing unit 98 and 99 between the pickup roller 92 and the regi roller 97 may sense the front end of the print medium P transported to the regi roller 97. A processor (not shown) may obtain the difference between the first time T1, which can be set for the transport of the print medium P from the pickup roller 92 to the sensing unit 98 and 99, and the second time T2 measured by sensing the print medium P transported from the pickup roller 92 to the sensing unit 98 and 99. The first time T1 may be the time premeasured starting from when the print medium P is picked up by the pickup roller 92 at the certain pickup position to when the front end of the print medium P is sensed by the sensing unit 98 and 99. The second time T2 may be the time measured from when the print medium P is picked up by the pickup roller 92 with the front end protruded to when the front end of the print medium P is sensed by the sensing unit 98 and 99. In some examples, the first time T1 may be predetermined based on the distance between the certain pickup position, at which the print medium P is picked up by the pickup roller 92, and a position, at which the sensing unit 98 and 99 senses the front end of the print medium P, and the rotating speed of the pickup roller 92.

The processor may adjust a first driving signal for adjusting a waiting position of the print medium P in the regi roller 97 and a second driving signal for feeding the print medium P, which is waiting at the adjusted position in the regi roller 97, to an image forming unit based on the difference between the first time T1 and the second time T2. In some examples, the processor may control the driving of the regi roller 97 using the adjusted first and second driving signals.

In some examples, the processor may prolong a first driving signal for adjusting a waiting position of the print medium P in the regi roller 97 and may delay a second driving signal for feeding the print medium P, which is waiting at a position adjusted according to the first driving signal, to an image forming unit based on the difference between the first time T1 and the second time T2.

For example, the processor may prolong the first driving signal and delay the start of the second driving signal by a time corresponding to the difference between the first time T1 and the second time T2 to control the driving of the regi roller 97. In some examples, although a distance that the print medium P arriving and waiting at the regi roller 97 can be further transported may not be exactly the same as C mm by which the front end of the print medium P protrudes from the certain pickup position because the rotating speed of the pickup roller 92 is higher than the rotating speed of the regi roller 97, there may not be an error. Accordingly, in some examples, when the first driving signal and the second driving signal are adjusted based on the time corresponding to the difference between the first time T1 and the second time T2, it may be handled as if the position of the print medium P having arrived at the regi roller 97 is further moved by C mm.

In another example, the processor may prolong the first driving signal such that the waiting position of the print medium P is further transported a distance corresponding to the difference between the first time T1 and the second time T2 and may delay the start of the second driving signal by a time that the first driving signal is prolonged. At this time, in some examples, a threshold of the distance corresponding to the difference between the first time T1 and the second time T2 may be a distance from the regi roller 97 to an upper roller closest to the regi roller 97 on a feeding route of the print medium P, In some examples, to adjust a distance that the print medium P arriving and waiting at the regi roller 97 is further transported to C mm by which the front end of the print medium P protrudes from the certain pickup position, the first driving signal and the second driving signal may be adjusted by increasing the time corresponding to the difference between the first time T1 and the second time T2 to be suitable for a driving of the regi roller 97. For example, the processor may prolong the first driving signal and delay the start of the second driving signal by a time obtained by increasing the time corresponding to the difference between the first time T1 and the second time T2 according to the reciprocal of a ratio of the rotating speed of the regi roller 97 to the rotating speed of the pickup roller 92, thereby controlling the driving of the regi roller 97.

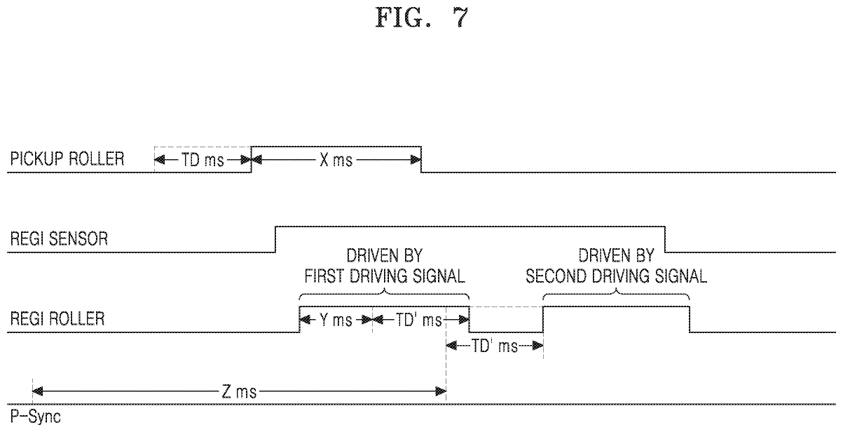

FIG. 7 is a diagram for describing an example adjustment of signals for controlling the driving of the regi roller 97 while the print medium feeding device 90 is feeding the print medium P having the front-end protruding from a certain pickup position.

In some examples, to reduce crumpling or slip marks in the print medium P when the print medium P is picked up at a position protruding from the certain pickup position, the print medium feeding device 90 may be controlled according to a time table shown in FIG. 7.

In FIG. 7, TD ms can be the difference between a first time (see T1 ms in FIG. 3) premeasured starting from when the print medium P is picked up by the pickup roller 92 at the certain pickup position to when the front end of the print medium P is sensed by the sensing unit 98 and 99 and a second time (see T2 ms in FIG. 5) measured from when the print medium P is picked up by the pickup roller 92 with the front end protruded to when the front end of the print medium P is sensed by the sensing unit 98 and 99. TD ms may be an indicator that indicates the degree of protrusion of the front end of the print medium P. For example, the more the front end of the print medium P protrudes, T2 ms decreases and TD ms increases.

Referring to FIG. 7, after a lapse of TD ms indicating the protrusion of the front end of the print medium P, the print medium P may be picked up with the front end thereof protruded and transported for X ms by the pickup roller 92. In some examples, after TD ms elapses until the front end of the print medium P protrudes from the certain pickup position and T2 ms further elapses, the front end of the print medium P may be sensed by the regi sensor 99 of the sensing unit 98 and 99. In some instances, after the front end of the print medium P is sensed by the regi sensor 99, front-end skew correction may be performed on the print medium P transported to the regi roller 97.

The processor, in some examples, may prolong a first driving signal for adjusting a waiting position of the print medium P in the regi roller 97 and may delay a second driving signal for feeding the print medium P, which is waiting at a position adjusted according to the first driving signal, to an image forming unit based on the difference between the first time T1 and the second time T2. In some examples, the first time T1 can be set for the transport of the print medium P from the pickup roller 92 to the sensing unit 98 and 99, and the second time T2 can be measured by sensing the print medium P transported from the pickup roller 92 to the sensing unit 98 and 99. As shown in FIG. 7, the processor may prolong the first driving signal by TD′ ms from Y ms and may delay the second driving signal by TD′ ms. TD′ ms may correspond to TD ms that is an indicator indicating the degree of protrusion of the front end of the print medium P. In some examples, when there is no difference or a difference below a threshold between the rotating speed of the pickup roller 92 and the rotating speed of the regi roller 97, TD′ ms may be treated as being the same as TD ms. In some examples where there is an unignorable difference between the rotating speed of the pickup roller 92 and the rotating speed of the regi roller 97, TD′ ms may be obtained by increasing TD ms, which can correspond to the degree of protrusion of the front end of the print medium P, according to the reciprocal of a ratio of the rotating speed of the regi roller 97 to the rotating speed of the pickup roller 92. The print medium feeding device 90 can include a roller in an upper position on a feeding route of the print medium P having a lower rotating speed, and accordingly, the first driving signal may be prolonged by TD′ ms that is longer than TD ms and the second driving signal may be delayed by TD ms.

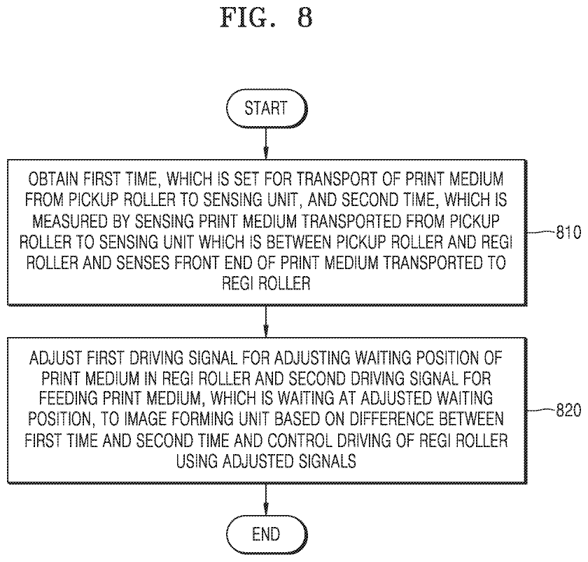

FIG. 8 is a flowchart of an example method of controlling the print medium feeding device 90.

In some examples, the above descriptions of the print medium feeding device 90 or the image forming apparatus 100 may also be applied to a method of controlling the print medium feeding device 90 even though omitted below.

In some instances, the print medium feeding device 90 may obtain the first time T1 and the second time T2 in block 810. The first time T1 can be set for the transport of the print medium P from the pickup roller 92 to the sensing unit 98 and 99, and the second time T2, can be measured by sensing the print medium P transported from the pickup roller 92 to the sensing unit 98 and 99. In some examples, the sensing unit 98 and 99 is between the pickup roller 92 and the regi roller 97 and senses the front end of the print medium P transported to the regi roller 97.

The first time T1, in some examples, may be premeasured starting from when the print medium P is picked up by the pickup roller 92 at a certain pickup position to when the front end of the print medium P is sensed by the sensing unit 98 and 99. The second time T2, in some examples, may be measured from when the print medium P is picked up by the pickup roller 92 with the front end protruded to when the front end of the print medium P is sensed by the sensing unit 98 and 99. In some examples, when the front end of the print medium P is not protruded from the certain pickup position, the second time T2 can be equal to the first time T1 or within a certain margin of error. In some examples, when the front end of the print medium P is protruded from the certain pickup position, the second time T2 can be shorter than the first time T1 according to the degree of the protrusion of the front end of the print medium P. For instance, this can be because a distance that the print medium P is transported to the regi roller 97 is shorter by the degree of protrusion of the front end of the print medium P when the front end of the print medium P is protruded.

In some examples, the print medium feeding device 90 may adjust a first driving signal for adjusting a waiting position of the print medium P in the regi roller 97 and a second driving signal for feeding the print medium P, which can be waiting at a position adjusted according to the first driving signal, to an image forming unit based on the difference between the first time T1 and the second time T2. In some examples, the print medium feeding device 90 may control driving of the regi roller 97 using the adjusted signals in block 820.

The print medium feeding device 90, in some examples, may prolong a first driving signal for adjusting a waiting position of the print medium P in the regi roller 97 and delay a second driving signal for feeding the print medium P (e.g., a print medium P waiting at a position adjusted according to the first driving signal) to an image forming unit, based on the difference between the first time T1 and the second time T2.

For example, the print medium feeding device 90 may prolong the first driving signal and delay the start of the second driving signal by a time corresponding to the difference between the first time T1 and the second time T2 to control the driving of the regi roller 97.

In some examples, even when the regi roller 97 is rotated longer by the time corresponding to the difference between the first time T1 and the second time T2 according to the prolonged first driving signal, the print medium P may be transported by the regi roller 97 a distance that is shorter than the distance corresponding to the degree of the protrusion of the front end of the print medium P because of a difference between the rotating speed of the pickup roller 92 and the rotating speed of the regi roller 97. In such an example, the print medium feeding device 90 may adjust the first driving signal and the second driving signal based on a distance corresponding to the difference between the first time T1 and the second time T2. The distance corresponding to the difference between the first time T1 and the second time T2 may be a distance that the print medium P is transported by the pickup roller 92 for a time corresponding to the difference between the first time T1 and the second time T2. At this time, in some examples, a threshold of the distance corresponding to the difference between the first time T1 and the second time T2 may be a distance from the regi roller 97 to an upper roller closest to the regi roller 97 on a feeding route of the print medium P.

For example, the print medium feeding device 90 may prolong the first driving signal such that the waiting position of the print medium P is further moved by the distance corresponding to the difference between the first time T1 and the second time T2 and may delay the start of the second driving signal by the time that the first driving signal is prolonged, thereby controlling the driving of the regi roller 97. In some examples, the print medium feeding device 90 may prolong the first driving signal and delay the start of the second driving signal by a time obtained by increasing the time corresponding to the difference between the first time T1 and the second time T2 according to the reciprocal of a ratio of the rotating speed of the regi roller 97 to the rotating speed of the pickup roller 92, thereby controlling the driving of the regi roller 97.

In some examples, the method of controlling the print medium feeding device 90 may include non-transitory computer-readable storage media that store data or commands executable by a computer or a processor. The method may be written as computer programs and may be implemented in general-use digital computers that execute the programs using a computer-readable storage medium. The computer-readable storage media may be read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tape, floppy disks, magneto-optical data storage devices, optical data storage devices, hard disks, solid state disks (SSDs), or any devices that can store a command or software, relevant data, a data file, and a data structure and can provide the command or software, the relevant data, the data file, and the data structure to a processor or a computer to allow the processor or computer to execute the command.

What is claimed is:

1. A print medium feeding device comprising:
a pickup roller to pick up a print medium stacked on a loading tray;
a forward roller to transport the print medium that has been picked up;
a registration roller to align a front end of the print medium that has been transported and to feed the print medium to an image forming unit;
a sensing unit between the pickup roller and the registration roller to sense the front end of the print medium transported to the registration roller; and
a processor to adjust a first driving signal and a second driving signal based on a difference between a first time and a second time and to control driving of the registration roller using adjusted signals, the first driving signal adjusting a waiting position of the print medium in the registration roller, the second driving signal feeding the print medium waiting at the adjusted waiting position to the image forming unit, the first time associated with transport of the print medium from the pickup roller to the sensing unit, and the second time being measured by sensing the print medium transported from the pickup roller to the sensing unit.

2. The print medium feeding device of claim 1, wherein:
the first time is premeasured starting from when the print medium is picked up by the pickup roller at a certain pickup position to when the front end of the print medium is sensed by the sensing unit; and
the second time is measured from when the print medium is picked up by the pickup roller with the front end protruded from the certain pickup position to when the front end of the print medium is sensed by the sensing unit.

3. The print medium feeding device of claim 1, wherein the processor is to control the driving of the registration roller by prolonging the first driving signal and delaying the second driving signal based on the difference between the first time and the second time.

4. The print medium feeding device of claim 3, wherein the processor is to control the driving of the registration roller by prolonging the first driving signal and delaying a start of the second driving signal by a time corresponding to the difference between the first time and the second time.

5. The print medium feeding device of claim 3, wherein the processor is to control the driving of the registration roller by prolonging the first driving signal to further move the waiting position of the print medium by a distance corresponding to the difference between the first time and the second time and by delaying a start of the second driving signal by a time that the first driving signal is prolonged.

6. The print medium feeding device of claim 5, wherein the processor is to control the driving of the registration roller by prolonging the first driving signal and delaying the start of the second driving signal by a time obtained by increasing a time corresponding to the difference between the first time and the second time according to a reciprocal of a ratio of a rotating speed of the registration roller to a rotating speed of the pickup roller.

7. The print medium feeding device of claim 5, wherein a threshold of the distance corresponding to the difference between the first time and the second time is a distance from the registration roller to an upper roller closest to the registration roller on a feeding route of the print medium.

8. A method of controlling a print medium feeding device, the method comprising:
obtaining a first time and a second time, the first time associated with transport of a print medium from a pickup roller to a sensing unit, the second time being measured by sensing the print medium transported from the pickup roller to the sensing unit, and the sensing unit being between the pickup roller and a registration roller and sensing a front end of the print medium transported to the registration roller; and
controlling driving of the registration roller using adjusted signals by adjusting a first driving signal and a second driving signal based on a difference between the first time and the second time, the first driving signal adjusting a waiting position of the print medium in the registration roller and the second driving signal feeding the print medium walking at the adjusted waiting position to an image forming unit.

9. The method of claim 8, wherein:
obtaining the first time comprises obtaining a premeasured time starting from when the print medium is picked up by the pickup roller at a certain pickup position to when the front end of the print medium is sensed by the sensing unit; and
obtaining the second time comprises obtaining a time that is measured from when the print medium is picked up by the pickup roller with the front end protruded from the certain pickup position to when the front end of the print medium is sensed by the sensing unit.

10. The method of claim 8, wherein the controlling of the driving of the registration roller comprises controlling the driving of the registration roller by prolonging the first driving signal and delaying the second driving signal based on the difference between the first time and the second time.

11. The method of claim 10, wherein the controlling of the driving of the registration roller comprises controlling the driving of the registration roller by prolonging the first driving signal and delaying a start of the second driving signal by a time corresponding to the difference between the first time and the second time.

12. The method of claim 10, wherein the controlling of the driving of the registration roller comprises controlling the driving of the registration roller by prolonging the first driving signal to further move the waiting position of the print medium by a distance corresponding to the difference between the first time and the second time and by delaying a start of the second driving signal by a time that the first driving signal is prolonged.

13. The method of claim 12, wherein the controlling of the driving of the registration roller comprises controlling the driving of the registration roller by prolonging the first driving signal and delaying the start of the second driving signal by a time obtained by increasing a time corresponding to the difference between the first time and the second time according to a reciprocal of a ratio of a rotating speed of the registration roller to a rotating speed of the pickup roller.

14. The method of claim 12, wherein the controlling of the driving of the registration roller comprises controlling the driving of the registration roller by prolonging the first driving signal and delaying the start of the second driving signal by the time obtained by increasing the time corresponding to the difference between the first time and the second time such that a threshold of the distance corresponding to the difference between the first time and the second time is a distance from the registration roller to an upper roller closest to the registration roller on a feeding route of the print medium.

15. A non-transitory computer-readable storage medium storing instructions executable by a processor, the non-transitory computer-readable storage medium comprising:
instructions to obtain a first time and a second time, the first time associated with transport of a print medium from a pickup roller to a sensing unit, the second time being measured by sensing the print medium transported from the pickup roller to the sensing unit, and the sensing unit being between the pickup roller and a registration roller and sensing a front end of the print medium transported to the registration roller; and
instructions to control driving of the registration roller using adjusted signals by adjusting a first driving signal and a second driving signal based on a difference between the first time and the second time, the first driving signal adjusting a waiting position of the print medium in the registration roller and the second driving signal feeding the print medium waiting at the adjusted waiting position to an image forming unit.
